(19) United States
(12) Patent Application Publication
(10) Pub. No.: US 2026/0051167 A1
(43) Pub. Date: Feb. 19, 2026

(54) PREDICTION OF WEED LOCATIONS IN FIELD OR OTHER GROWING AREA

(71) Applicant: Geco Strategic Weed Management Inc., North Vancouver (CA)

(72) Inventors: Gregory E. Stewart, North Vancouver (CA); Devin G. Kirk, Langley (CA)

(21) Appl. No.: 19/368,880

(22) Filed: Oct. 24, 2025

Related U.S. Application Data
(63) Continuation of application No. PCT/IB2024/054398, filed on May 7, 2024.
(60) Provisional application No. 63/501,888, filed on May 12, 2023.

(51) Int. Cl. G06V 20/10; A01B 79/00; G06V 20/13

(52) U.S. Cl. CPC G06V 20/188; A01B 79/005; G06V 20/13

(57) ABSTRACT

A method includes obtaining plant-related information associated with a growing area, where the plant-related information includes information identifying multiple weeds detected within the growing area. The method also includes processing at least some of the plant-related information to estimate at least one location at risk of weed germination in the growing area. Processing at least some of the plant-related information includes estimating the at least one location at risk of weed germination based at least partially on locations where the identified weeds were detected within the growing area. Estimating the at least one location at risk of weed germination may include performing clustering based on the locations where the identified weeds were detected within the growing area, such as by performing the clustering using a machine learning clustering algorithm.

### CROSS-REFERENCE TO RELATED APPLICATIONS AND PRIORITY CLAIM

This application claims priority as a bypass continuation of International Patent Application No. PCT/IB2024/054398 filed on May 7, 2024, which claims priority to U.S. Provisional Patent Application No. 63/501,888 filed on May 12, 2023. Both of these applications are hereby incorporated by reference in their entirety.

### TECHNICAL FIELD

This disclosure is generally directed to prediction systems. More specifically, this disclosure is directed to prediction of weed locations in a field or other growing area.

### BACKGROUND

Chemical herbicides are a primary tool for the control of weeds in modern agricultural production. In many farm fields or other growing areas, weeds often grow in patches, and the patches may be located anywhere within the growing areas. Common locations of weed patches may include around the edges of a field or other growing area or in areas where soil is locally more favorable to weeds than crops, such as when the weed kochia tends to be advantaged relative to most crops in saline and dry soil areas or when weed seeds have accumulated due to environmental, human, or animal factors. Chemical herbicides are a common and very effective tool for controlling weeds. Chemical herbicides are often either soil-applied (applied directly onto the soil) or foliar-applied (applied directly onto the leaves or other portions of the weeds).

### SUMMARY

This disclosure relates to prediction of weed locations in a field or other growing area.

In a first embodiment, a method includes obtaining plant-related information associated with a growing area, where the plant-related information includes information identifying multiple weeds detected within the growing area. The method also includes processing at least some of the plant-related information to estimate at least one location at risk of weed germination in the growing area. Processing at least some of the plant-related information includes estimating the at least one location at risk of weed germination based at least partially on locations where the identified weeds were detected within the growing area.

In a second embodiment, an apparatus includes at least one processing device configured to obtain plant-related information associated with a growing area, where the plant-related information includes information identifying multiple weeds detected within the growing area. The at least one processing device is also configured to process at least some of the plant-related information to estimate at least one location at risk of weed germination in the growing area. To process at least some of the plant-related information, the at least one processing device is configured to estimate the at least one location at risk of weed germination based at least partially on locations where the identified weeds were detected within the growing area.

In a third embodiment, a non-transitory machine readable medium includes computer readable program code that when executed causes at least one processor to obtain plant-related information associated with a growing area, where the plant-related information includes information identifying multiple weeds detected within the growing area. The non-transitory machine readable medium also includes computer readable program code that when executed causes the at least one processor to process at least some of the plant-related information to estimate at least one location at risk of weed germination in the growing area. The computer readable program code that when executed causes the at least one processor to process at least some of the plant-related information includes computer readable program code that when executed causes the at least one processor to estimate the at least one location at risk of weed germination based at least partially on locations where the identified weeds were detected within the growing area.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting the prediction of weed locations in a field or other growing area according to this disclosure;

FIG. 2 illustrates an example computing device supporting the prediction of weed locations in a field or other growing area according to this disclosure;

FIG. 3 illustrates an example architecture supporting the prediction of weed locations in a field or other growing area according to this disclosure;

FIGS. 4A through 4E illustrate example historical data used for prediction of weed locations in a field or other growing area according to this disclosure;

FIGS. 5A through 5C illustrate example predictions of weed locations in a field or other growing area according to this disclosure;

FIGS. 6A through 6C illustrate example tunings for predictions of weed locations in a field or other growing area and associated results according to this disclosure;

FIGS. 7A through 7G illustrate specific examples of systems in which predictions of weed locations in a field or other growing area may be used according to this disclosure; and

FIG. 8 illustrates an example method for predicting weed locations in a field or other growing area according to this disclosure.

### DETAILED DESCRIPTION

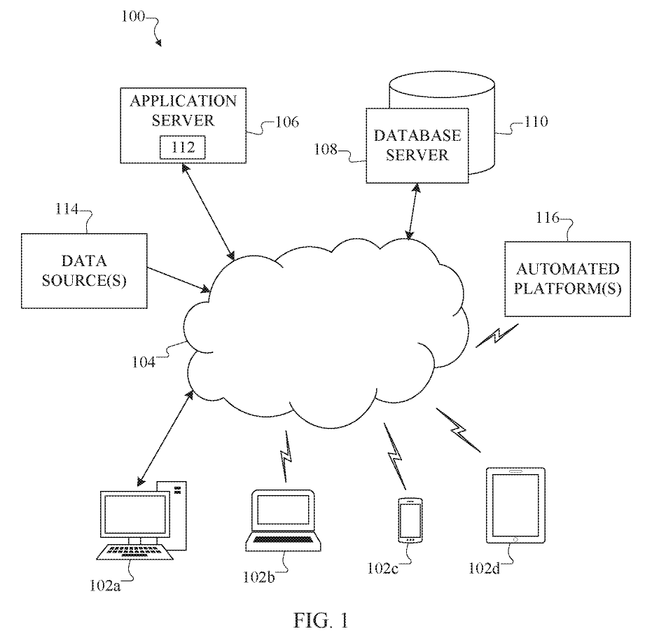

FIGS. 1 through 8, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, chemical herbicides are a primary tool for the control of weeds in modern agricultural production. In many farm fields or other growing areas, weeds often grow in patches, and the patches may be located anywhere within the growing areas. Common locations of weed patches may include around the edges of a field or other growing area or in areas where soil is locally more favorable to weeds than crops, such as when the weed kochia tends to be advantaged relative to most crops in saline and dry soil areas or when weed seeds have accumulated due to environmental, human, or animal factors. Chemical herbicides are a common and very effective tool for controlling weeds. Chemical herbicides are often either soil-applied (applied directly onto the soil) or foliar-applied (applied directly onto the leaves or other portions of the weeds).

Traditionally, herbicides have been applied during a blanket application. For example, a sprayer may pass over an entire growing area and spray herbicide everywhere, whether or not there are weeds present. Herbicides in other forms (such as granular herbicides) can also be deposited over an entire growing area. This is considered to be the safest approach since it is assured to hit almost every weed. However, it results in wasted chemical herbicide that costs money, and the chemical herbicide can end up in the soil and/or streams, rivers, groundwater, or other water sources.

As a particular example, herbicides can have a wide range in terms of costs and in terms of their effectiveness against certain weeds. An herbicide application is often cost-effective if the cost of the herbicide application is lower than the obtained benefits. In a simple calculation, consider weeds putting a crop yield at risk. Assume that the weeds cover a fraction F of a field or other growing area. Also assume that crop revenue has a monetary value of y per square meter and that the herbicide cost has a monetary value of x per square meter. Further assume that the herbicide suppresses weeds so that crops can grow in place of the weeds. Thus, if the fraction F of weed coverage of the field or other growing area is greater than x/y, a blanket herbicide application may be profitable. If the fraction F of weed coverage of the field or other growing area is less than x/y, a blanket herbicide application may not be profitable. As a result, if an herbicide costs one third of a crop’s profit per square meter, a blanket application of that herbicide may only be profitable if weeds cover more than one third of the growing area. For expensive herbicides or for weeds that cover only a small fraction of a growing area, a blanket application of herbicide is typically not economically sound.

With foliar-applied herbicides, it is becoming more common to do site-specific treatments, such as when tractor, all-terrain vehicle (ATV), drone, or other vehicle-based sprayers are instrumented with cameras or other sensors to locate and treat only weeds. These approaches may include so-called “green on brown” approaches in which a sensor identifies weeds against the bare ground and “green on green” approaches in which a sensor identifies weeds within a growing crop. “Green on green” approaches typically require a camera and a computer vision system to recognize and differentiate weeds from crops. Other approaches may use drones that are instrumented with cameras or other sensors to identify weeds only. At a coarser level, people may simply treat known big and bad patches of weeds. Camera-based or other sensor-based herbicide applicators can commonly save between 30% to 90% of chemicals by treating only weeds and not surrounding areas, although the actual amount saved can depend on the prevalence of weeds in a growing area.

Unfortunately, these and other approaches often suffer from various shortcomings, some of which are associated with use during vision-limited situations. For example, soil-applied residual herbicides are typically applied to the soil ahead of germination of weeds so that, as the weeds germinate and grow, they metabolize the herbicide and die. However, these approaches typically require treating large portions of a growing area since it is unclear where the weeds might grow. As another example, in dense crops (such as cereals instead of row crops), cameras and other sensors can often have difficulty seeing and differentiating weeds from crops. As yet another example, in mature crops, once the crops germinate and become established, the crops can hide weeds. While green-on-green systems can perform better with a more mature crop than green-on-brown systems, both are eventually limited. As still another example, challenging environments can include the presence of dust or other materials that can confuse the cameras or other sensors.

In general, predicting weed emergence so that only certain parts of a growing area are treated with herbicide is difficult and depends on many factors each growing season. These factors may include complex interactions of variables, such as weather conditions, crop competitiveness, and soil composition. With respect to weather conditions, factors such as temperature and moisture often need to be just right for a weed seed to germinate. With respect to crop competitiveness, some crops are more competitive with weeds than others, meaning competition is a function of specific weed-crop combinations. With respect to soil composition, factors such as salinity can affect how well crops or weeds grow. Simply using historical data may not necessarily be helpful. Multiple years of weed growth can show significantly different emergence patterns of weeds over time, and attempting to predict current weed growth based on prior weed growth can be quite challenging.

This disclosure describes various techniques supporting the prediction of weed locations in a field or other growing area, where the weeds can spread based on biological mechanisms or other spreading mechanisms. For example, this disclosure describes techniques in which the distribution of the risk of a germinating weed population can be estimated. In some embodiments, the described techniques may be used to identify one or more areas at risk of weed germination, such as due to the presence of an underlying seedbank in soil. In some cases, this may be accomplished using at least one trained machine learning model, such as a machine learning model trained to perform clustering. Based on the estimate of one or more areas at risk of germinating weeds, one or more recommendations can be produced or initiated for applying herbicide to the one or more areas that are estimated as being at risk. For instance, the one or more recommendations may be provided to human personnel for implementation and/or provided to one or more automated systems (such as tractor-based, ATV-based, or drone-based herbicide application systems). Any recommendations provided to an automated system may or may not require human approval prior to implementation of the recommendations by the automated system.

Note that the phrases “weed seedbank” and “seedbank” are used in this document to refer to at least one collection of weed seeds that could potentially germinate and produce weeds within at least one growing area. A weed seedbank typically (but not necessarily) is associated with seeds that are underground and waiting for the right conditions to germinate. As a result, weed seedbanks are typically not detectable to the naked eye and are often only discovered by human personnel after weeds have germinated.

Also note that weeds may or may not actually germinate in each area that is identified as having a risk of germination. For example, as noted above, whether or not a weed germinates from a weed seed can depend on various factors like weather conditions (such as temperature and moisture), weed-crop combinations, crop management actions, and soil composition. However, the ability to treat locations where weeds are likely to germinate from weed seeds in an underlying seedbank may help to significantly reduce the number of weeds that successfully grow within a growing area. This can often be achieved with significant reductions in the amount of herbicide used.

In addition, note that while spraying of an herbicide is often described in this document as being used to treat weeds or areas with weed seedbanks or that are otherwise at risk of weed germination in order to control weed populations, one or more chemical herbicides or other herbicides may be deployed in any suitable manner. For example, some herbicides have a solid form, such as when the herbicides are applied in granular form. As a result, various types of equipment may be used to apply one or more herbicides, such as one or more sprayers, granular applicators, or seed drills. Also, as described below, other types of treatments may be used along with or instead of herbicides. Examples of various types of treatments discussed below include a multi-rate application of an herbicide, a multi-herbicide application of multiple herbicides, an increase in seeding density for crops, a change in crop, a blanket application of herbicide, and a targeted application of one or more nutrients and/or fertilizer. The terms “treatment” and “treatments” are used in this document to encompass one or more actions (whether preventative or remedial) that can reduce the number or presence of weeds in at least one growing area.

FIG. 1 illustrates an example system 100 supporting the prediction of weed locations in a field or other growing area according to this disclosure. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100. In some cases, one or more users may use one or more user devices 102a-102d to identify weeds in at least one growing area. In other cases, one or more users may use one or more user devices 102a-102d to view a graphical user interface or other interface that presents analysis results (such as an identification of any areas at risk of weed emergence predicted within a growing area) and trigger any suitable actions (such as scheduling or approving herbicide application or other treatments in the risk areas).

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 may represent a combination of networks. For instance, the one or more user devices 102a-102d may communicate over a local area network, and the one or more application servers 106 and the one or more database servers 108 may be remote (possibly located within a cloud-based environment) and may communicate with the local area network over a wide area network or global network.

The application server 106 is coupled to the network 104 and is coupled to or otherwise communicates with the database server 108. The application server 106 supports the analysis of data (which may be obtained from one or more data sources 114 and stored in the database 110) in order to estimate the locations of weed risk areas. Example operations that may be performed by the application server 106 are described below. In some embodiments, the application server 106 may execute one or more applications 112 that use data from the database 110 to estimate the locations of weed risk areas. In some cases, the application 112 identifies spatial areas where weeds are at risk of emerging using a clustering algorithm. Note that the database server 108 may also be used within the application server 106 to store information, in which case the application server 106 itself may store the information used to predict the locations of areas at risk of weeds emerging.

The database server 108 operates to store and facilitate retrieval of various information used, generated, collected, or provided by the application server 106, the user devices 102a-102d, the data sources 114, and/or other components in the database 110. For example, the database server 108 may store various information related to vegetation or other information related to weeds or other plants detected in one or more growing areas.

The one or more data sources 114 may represent any suitable source(s) of data analyzed by the application server 106 to estimate the locations of areas at risk of weed germination. For example, the one or more data sources 114 may include one or more sources of satellite images or other satellite-based data or other remotely-sensed data associated with at least one field or other growing area. In some cases, the satellite-based data may include multi-spectral data. As a particular example, the satellite-based data may include normalized difference vegetation index (NDVI) data. The one or more data sources 114 may also or alternatively include one or more sources of image data or other data captured using at least one smart spraying system or other smart herbicide application system, such as data captured using cameras or other imaging sensors on one or more tractors, ATVs, airborne drones, or other vehicles that are equipped with systems for selectively spraying weeds or otherwise applying herbicide. The one or more data sources 114 may also or alternatively include one or more sources of image data or other data captured using at least one surveying device, such as data captured using cameras or other imaging sensors on one or more tractors, ATVs, drones, or other vehicles designed to provide surveying (but not herbicide application) capabilities. The disclosed techniques may also combine and coordinate usage of various data sources, such as by combining and coordinating usage of one or more data sources that are lower-fidelity and more frequent with one or more data sources that are higher-fidelity and less frequent. Note, however, that any other suitable source(s) of data may be used here. For instance, data sources used for prediction may also include one or more agronomically-relevant data sources, such as one or more sources of human-collected scouting data, meteorological data, soil type data, weed species data, and data defining management practices. The human-collected scouting data may include locations of weeds as identified by human personnel scouting a growing area.

One or more automated platforms 116 may optionally be used in the system 100. In some cases, the one or more automated platforms 116 may include one or more platforms that can identify weeds in one or more growing areas. For example, the one or more automated platforms 116 may include tractors, ATVs, drones, or other devices configured to identify weeds during a survey or other operations. The one or more automated platforms 116 may also or alternatively include one or more camera-enabled or other sensor-enabled smart spraying systems or other herbicide application systems, such as tractors, ATVs, drones, or other devices configured to apply treatments to weeds while trying to avoid treating other plants like crops. As a result, the same device may represent both a data source 114 and an automated platform 116. However, an automated platform 116 may also represent a platform that does not function as a data source 114, such as when an automated platform 116 represents a tractor-based, ATV-based, drone-based, or other spraying system or other herbicide application system that does not differentiate between weeds and other plants. One or more of the automated platforms 116 may optionally be controlled based on predictions of areas at risk of weed germination, such as when at least one smart or other tractor-based, ATV-based, drone-based, or other spraying system or other herbicide application system can be controlled to apply herbicide at the predicted locations of one or more areas at risk of weed germination.

Although FIG. 1 illustrates one example of a system 100 supporting the prediction of weed locations in a field or other growing area, various changes may be made to FIG. 1. For example, various components shown in FIG. 1 may be combined, further subdivided, replicated, omitted, or rearranged and additional components may be added according to particular needs. Also, the system 100 may include any number of user devices 102a-102d, networks 104, application servers 106, database servers 108, databases 110, data sources 114, and automated platforms 116 (possibly including zero of one or more of these components). Further, these components may be located in any suitable locations and might be distributed over a large area. In addition, while FIG. 1 illustrates one example operational environment in which the prediction of weed locations in a field or other growing area may be used, this functionality may be used in any other suitable system.

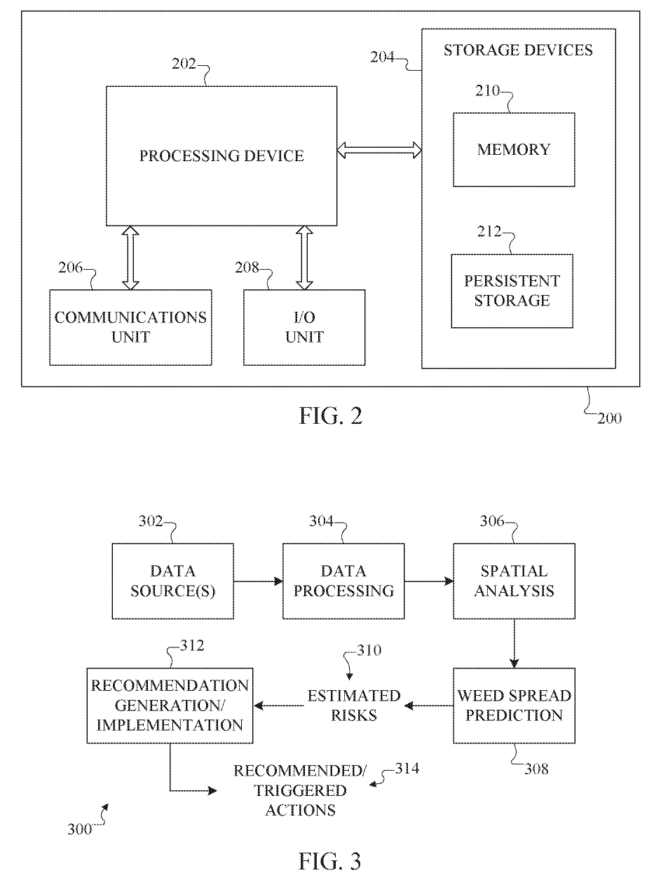

FIG. 2 illustrates an example computing device 200 supporting the prediction of weed locations in a field or other growing area according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, data source 114, or automated platform 116 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. In some embodiments, the processing device 202 may execute instructions to predict weed locations in a field or other growing area based on biological spreading mechanisms or other spreading mechanisms. The processing device 202 may also execute instructions to generate recommendations or trigger treatments in response to the predictions. Examples of the types of functions that may be performed using the processing device 202 are provided below. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting the prediction of weed locations in a field or other growing area, various changes may be made to FIG. 2. For example, various components shown in FIG. 2 may be combined, further subdivided, replicated, omitted, or rearranged and additional components may be added according to particular needs. Also, computing and communication devices and systems come in a wide variety of configurations, and FIG. 2 does not limit this disclosure to any particular computing or communication device or system.

FIG. 3 illustrates an example architecture 300 supporting the prediction of weed locations in a field or other growing area according to this disclosure. For ease of explanation, the architecture 300 of FIG. 3 is described as being implemented using the application server 106 in the system 100 of FIG. 1, where the application server 106 may be implemented using one or more instances of the device 200 of FIG. 2. However, the architecture 300 may be implemented using any other suitable device(s) and in any other suitable system(s).

As shown in FIG. 3, the architecture 300 includes or has access to one or more data sources 302, which can provide information to be processed by the architecture 300. The one or more data sources 302 may include any suitable source(s) of relevant weed-related or plant-related data, such as the database 110 and/or the one or more data sources 114. The one or more data sources 302 may provide any suitable information to the architecture 300 for processing, such as various information related to vegetation or other information related to weeds or other plants in one or more growing areas. Specific examples can include satellite images or other satellite-based data or other remotely-sensed data (such as multi-spectral data or multi-spectral metrics like NDVI data), image data or other data captured using at least one smart herbicide application system, image data or other data captured using at least one surveying device, human-collected scouting data, meteorological data, soil type data, weed species data, data defining management practices, or any combination thereof.

In some cases, different data sources 302 having different frequencies, resolutions, and fidelities may be used. With respect to frequency, for example, satellites may provide imagery of a field or other growing area more frequently (such as several times per week), while a tractor, ATV, airborne drone, or other vehicle may be used in the growing area less frequently (such as once per month). With respect to resolution, some emerging high-resolution drones or other sensors may provide data with very fine spatial resolution (such as a sub-millimeter resolution), while satellites typically have coarser spatial resolution (such as a resolution of about three to ten meters). With respect to fidelity, lower-fidelity data may include NDVI maps only, while higher-fidelity data may include weed count, weed species, weed age, or weed health.

An ideal dataset representing data from all of the data sources 302 could have high frequency, high resolution, and high fidelity. However, in reality, typically-available data sources 302 tend to be more of a mix, which is why a combination of data sources 302 may be useful. In some cases, for example, satellites may have higher frequency, lower resolution, and lower fidelity. A commercial drone may have lower frequency, medium resolution, and lower or medium fidelity. A high-resolution drone may have lower frequency, higher resolution, and higher fidelity. An optical “green on brown” spot sprayer or other herbicide applicator may have lower frequency, medium resolution, and lower fidelity. An optical “green on green” spot sprayer or other herbicide applicator may have lower frequency, higher resolution, and higher fidelity. Thus, a combination of data from these various data sources 302 may be used to achieve improved results. In some embodiments, satellite data is routinely available and can be used by the architecture 300 (although that may not be true in all cases). Depending on what vehicles or other sensors are in use in a given field or other growing area, data from at least one optical spot sprayer or other herbicide applicator (like a tractor), camera-equipped drone, human scout, camera-equipped tractor, or any combination thereof may be used as one or more data sources 302. Note that the descriptions of the various data sources 302 above are examples only and may vary depending on the circumstances.

One or more data processing functions 304 receive the data from the data sources 302 and process the data in order to prepare the data for use by subsequent functions. For example, one or more data processing functions 304 may involve georeferencing data in order to associate specific plant-related data with one or more specific fields or other growing areas and identifying boundaries of the one or more fields or other growing areas. This allows the architecture 300 to identify which of the data being processed relates to which field or other growing area. The one or more data processing functions 304 may also involve converting plant-related data into weed maps. A weed map generally represents a spatial map of at least one growing area that identifies locations of weeds within the growing area(s), possibly along with weed-related information (such as weed type, weed size, etc.). For instance, the one or more data processing functions 304 may generate a graphical image representing each field or other growing area, where any locations of weeds in the growing area are identified in the graphical image. In some cases, weed maps can be generated by identifying anomalies in NDVI data. The one or more data processing functions 304 may further involve combining data from different time points and/or data sources 302 into a common or standardized format. For instance, locations (and possibly other information) about weed locations identified in data from various data sources 302 may be combined into a standard format for identifying the weeds.

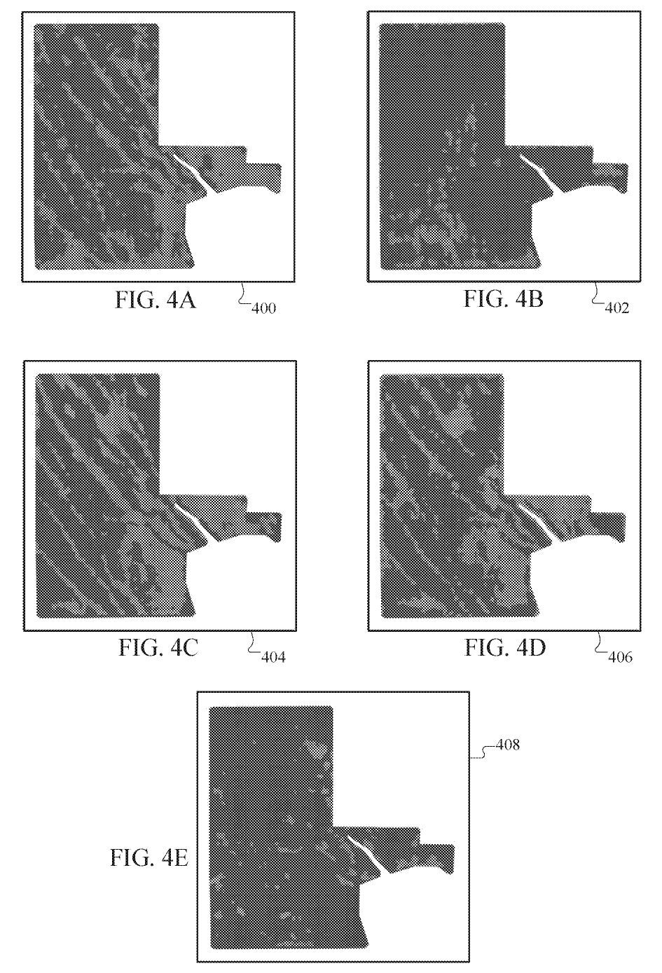

At least one machine learning-based or other spatial analysis function 306 can process the weed-related information and other information to perform clustering based on locations where weeds have been detected within the one or more fields or other growing areas. For example, the spatial analysis function 306 may involve identifying locations where weeds have been previously observed at any time within a relevant window. In some cases, the relevant window may be determined based on a weed seedbank’s estimated survival, which can be at least partly dependent on weed species, soil, and weather. As particular examples, the relevant window may be between one to ten years. One example of the type of data that may be used by the spatial analysis function 306 is shown in FIGS. 4A through 4E, which illustrate example historical data used for prediction of weed locations in a field or other growing area according to this disclosure. More specifically, FIGS. 4A through 4E illustrate example weed maps 400-408 that identify locations of weeds over multiple growing seasons (such as five years). The differences in weed distributions here can be due to a number of factors, such as weather, soil, topography, crop competition, and crop management techniques. As a particular example, the weed map 400 may be associated with weeds that grew with a first type of crop planted, the weed maps 402 and 408 may be associated with weeds that grew with a second type of crop planted, and the weed maps 404 and 406 may be associated with weeds that grew with a third type of crop planted.

The spatial analysis function 306 may also involve combining or weighting identified weed locations from multiple time points to create maps of weed germination risk. As an example, locations in which weeds appear more frequently during multiple years or other time periods could be weighted more heavily than locations in which weeds appear less frequently. As another example, the type of crop currently planted (or to be planted) in a growing area can affect weed growth, and weed locations associated with prior plantings of the same type of crop could be weighted more heavily than weed locations associated with prior plantings of other types of crops. The spatial analysis function 306 may further involve determining relevant distances between weeds in a growing area and clustering weed data points. In some cases, the weed data points may be clustered using a machine learning clustering algorithm, such as one that performs density-based clustering.

The spatial analysis function 306 may also involve removing outlier weed data points that have not been assigned a cluster and calculating borders around each weed cluster in the growing area(s), which may be expressed in the form of convex hulls or in any other suitable manner. In some cases, each cluster of weeds can be defined using one or border lines that define the shape of the cluster. The removal of the outlier weed data points can help to reduce the areas to be treated since the outlier weed data points may generally represent small numbers of weeds that could be spot-treated manually or in other ways or simply ignored. The spatial analysis function 306 may further involve combining the borders into spatial polygons or other weed population boundaries associated with the clusters. The conversion of cluster boundaries into spatial polygons may enable simpler processing or storage of the cluster borders, although this may not necessarily be needed. In some cases, a buffer may be incorporated around each weed data point representing a weed assigned to a cluster, and these points may be combined in order to form the spatial polygons or other geometric boundaries. Moreover, each cluster boundary can be restricted to occur within the boundaries of the associated field or other growing area. In addition, the spatial analysis function 306 may involve incorporating an additional buffer zone around each spatial polygon or other population boundary that represents a distance at which an unobserved portion of a weed population may occur. This helps to account for the fact that weed seeds often typically have spread beyond observable boundaries of actual weeds that have already germinated.

A weed spread prediction function 308 can receive the predictions generated by the spatial analysis function 306 and generate predictions regarding how the identified weeds or clusters of weeds are likely to spread over time. The weed spread prediction function 308 may model any suitable biological or other spread prediction function(s) that can incorporate estimates of how weed populations are predicted spread over time. In some cases, the weed spread prediction function 308 may incorporate an additional area around each spatial polygon or other weed population boundary, where the additional area represents a distance at which a weed population is predicted to grow within a relevant time window (such as during the current growing season). This results in the generation of estimated risks 310, which represent or include the estimated locations of weed populations and how those weed populations are expected to grow and spread in one or more growing areas.

In some embodiments, a recommendation generation/implementation function 312 may optionally be used to process the estimated risks 310 in order to generate outputs 314, which can include recommended actions that may be reviewed and possibly performed manually or triggered actions that may be performed automatically (with or without human approval). For example, the recommendation generation/implementation function 312 may generate recommendations to spray or otherwise treat specific portions of a growing area associated with predicted areas at risk of weed germination. As another example, the recommendation generation/implementation function 312 may generate instructions that cause at least one automated spraying system or other automated treatment system to treat specific portions of a growing area associated with predicted areas at risk of weed germination.

Note that recommended or triggered actions here may represent various forms of treatments. For example, an herbicide application may be recommended or triggered, which generally involves spraying or other application of an herbicide once. A multi-rate herbicide application may be recommended or triggered, which generally involves multiple applications of herbicide at different rates at different times. A multi-herbicide application may be recommended or triggered, which generally involves multiple applications of different herbicides (possibly at different rates) at different times. An increase in seeding density may be recommended or triggered, which generally involves planting or otherwise increasing the density of crop seeds in areas where more weeds are growing (such as in an attempt to crowd out the weeds). A change in crop may be recommended or triggered, which generally involves planting or otherwise placing a different crop in areas where more weeds are growing (such as in an attempt to crowd out the weeds). A blanket application of herbicide may be recommended or triggered if numerous weed clusters covering a large portion of a growing area are identified, which generally involves applying herbicide over most or all of the growing area. A targeted application of nutrients and/or fertilizer may be recommended or triggered, which generally involves application of one or more nutrients and/or fertilizer to an area to help promote crop growth (which may crowd out weeds).

Also note that, in some embodiments, the architecture 300 may support one or more additional functions as needed or desired. For example, International Patent Publication No. WO 2023/131851 (which is hereby incorporated by reference in its entirety) discloses various techniques for analyzing spatial information associated with weeds in growing areas in order to identify areas where weeds have developed or may be developing herbicide resistance. This type of functionality may be incorporated in various ways into the architecture 300. For instance, the spatial analysis function 306 may use this functionality to detect actual or possible herbicide resistance when identifying clusters of weeds. The weed spread prediction function 308 may use this functionality to predict how weeds with actual or possible herbicide resistance might spread over time. The recommendation generation/implementation function 312 may use this functionality to recommend or initiate the use of different herbicides to treat weeds with actual or possible herbicide resistance.

In addition, note that the functions shown in or described with respect to FIG. 3 can be implemented in the application server 106, user device 102a-102d, or other device(s) in any suitable manner. For example, in some embodiments, at least some of the functions shown in or described with respect to FIG. 3 can be implemented or supported using one or more software applications or other software instructions that are executed by the at least one processing device 202 of the application server 106, user device 102a-102d, or other device(s). In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions. Also, the functions shown in or described with respect to FIG. 3 can be performed by a single device or by multiple devices.

As described above, the architecture 300 can be used to effectively predict where weeds are more likely to emerge, which allows for treatment of those areas in order to reduce weed emergence or weed growth. Among other things, this can help to reduce or minimize herbicide usage and reduce costs. As a particular example of this, optical spot-sprayers refer to tractors or other vehicles equipped with an array of cameras and processing capabilities for detecting and targeting weeds that have emerged at the time of spraying. One challenge growers face when using optical spot-sprayers involves the preparation of chemical herbicide for spraying. When a grower enters a specific field or other growing area (such as a 160-acre field), the grower does not necessarily know how many acres will need to be sprayed until after the sprayer is driven over the entire growing area. If the grower mixes one hundred acres’ worth of herbicide and then discovers only sixty acres need to be sprayed, the grower has an additional forty acres of herbicide that needs to be disposed of or used, such as in another growing area. The predictive power of the architecture 300 can be used ahead-of-time to estimate how much area might need to be sprayed or otherwise treated, allowing a more appropriate quantity of herbicide to be prepared for use.

Although FIG. 3 illustrates one example of an architecture 300 supporting the prediction of weed locations in a field or other growing area, various changes may be made to FIG. 3. For example, various components or functions in FIG. 3 may be combined, further subdivided, replicated, omitted, or rearranged and additional components or functions may be added according to particular needs.

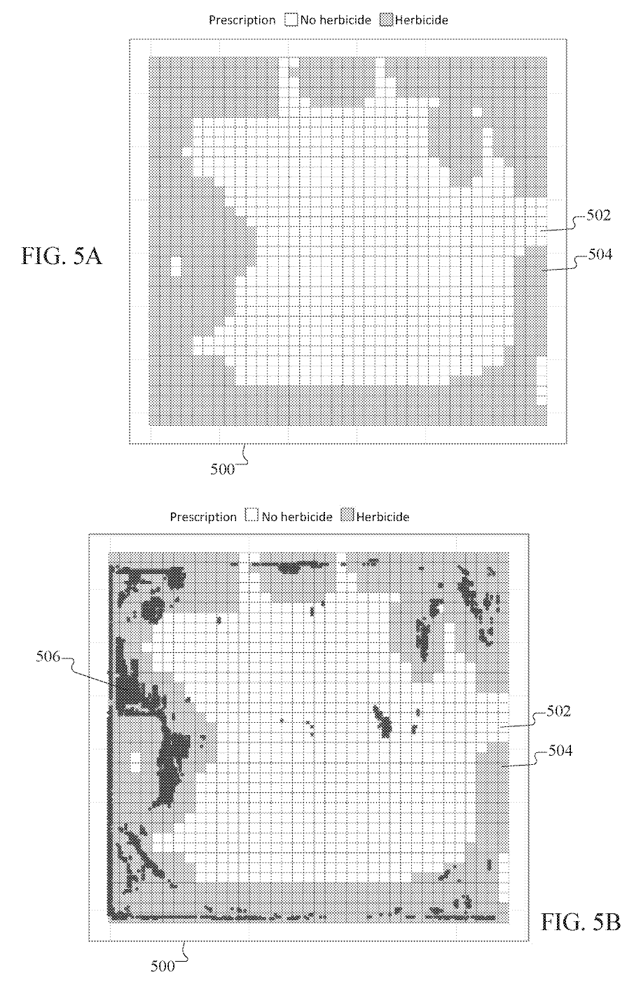

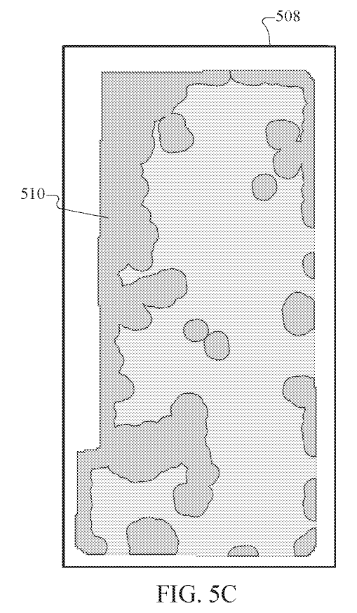

FIGS. 5A through 5C illustrate example predictions of weed locations in a field or other growing area according to this disclosure. For ease of explanation, these predictions may be generated using the application server 106 in the system 100 of FIG. 1, where the application server 106 may be implemented using one or more instances of the device 200 of FIG. 2 and may implement at least part of the architecture 300 of FIG. 3. However, any other suitable predictions may be generated by the application server 106 or the architecture 300.

As shown in FIG. 5A, a graphical representation 500 represents a field or other growing area. A grid pattern may be used to divide the growing area into smaller cells 502. The graphical representation 500 may have any suitable scale. In some cases, for instance, the graphical representation 500 may represent a growing area having a width of 800 meters, although the scale of the graphical representation 500 can vary. Also, in some cases, it may be possible to zoom into and out of the graphical representation 500 to view the growing area at different scales. In this example, the graphical representation 500 also includes shading or another indicator 504 in each cell 502 where weeds are predicted to occur. The cells 502 with the indicators 504 here can be identified by the architecture 300 as being areas where treatment should be applied. As a particular example, the treatment may represent an herbicide, such as a pre-emergent that is being applied to the bare ground in order to try and kill weeds prior to emerging, as the weeds begin to emerge, or after germination.

As shown in FIG. 5B, indicators 506 have been added to identify where weeds actually emerge during a growing season. As shown here, a large majority of the indicators 506 reside in cells 502 having the indicators 504, meaning that the predictions made by the architecture 300 closely matched where weeds actually germinated. Assuming the applied treatment kills most of these weeds, the applied treatment in this example may be applied to locations for about 93% or more of the germinating weeds. Because the applied treatment here is applied in specific cells 502 and not everywhere, this may reduce herbicide usage by about 60% or more.

The form of the graphical representation 500 shown here is for illustration only and can easily vary depending on the implementation. For example, as shown in FIG. 5C, a graphical representation 508 may include different indicators 510 identifying areas where weeds are predicted to occur. As can be seen here, the graphical representation 500 need not be divided into cells. Also, the indicators 510 are not per cell and are rather more freeform in shape, which in some cases may allow for the application of herbicide or other treatments to occur on a more refined basis (rather than just applying the treatment in the entirety of each cell 502 with an indicator 504).

Although FIGS. 5A through 5C illustrate examples of predictions of weed locations in a field or other growing area, various changes may be made to FIGS. 5A through 5C. For example, the specific forms in which the predictions are generated or presented can easily vary depending on the implementation. Thus, for instance, any number of graphical representations may be used to present predictions of weed locations. Also, the use of a graphical representation may not be needed, such as when predictions are presented to users in other forms or are not presented to users.

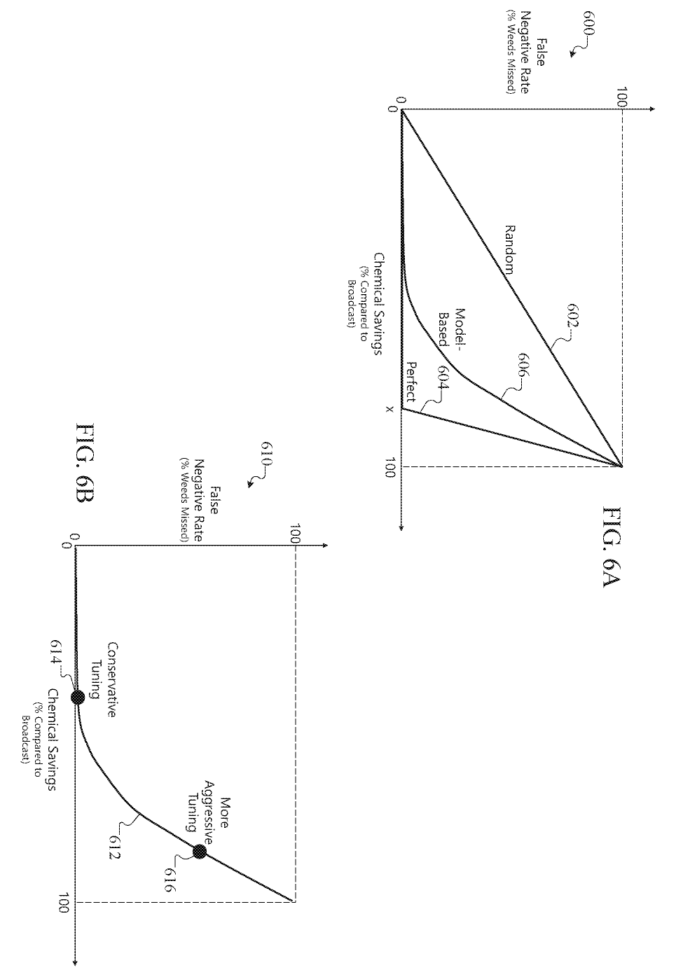

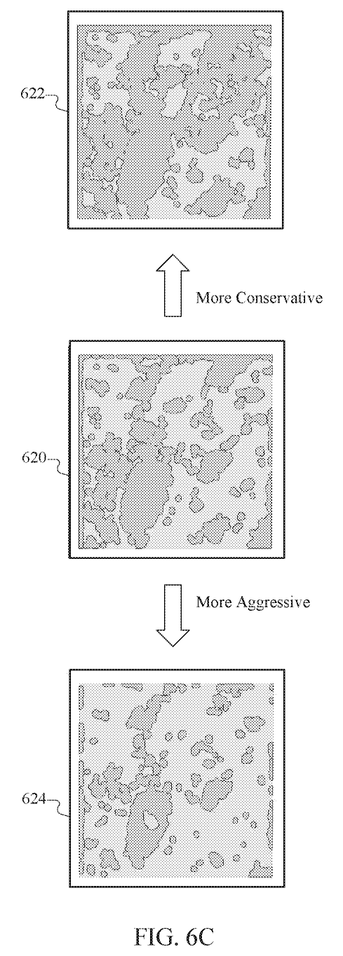

FIGS. 6A through 6C illustrate example tunings for predictions of weed locations in a field or other growing area and associated results according to this disclosure. More specifically, FIGS. 6A through 6C illustrate how the architecture 300 could potentially be tuned when generating predictions of weed locations.

As shown in FIG. 6A, a graph 600 plots different curves 602-606 that illustrate the effectiveness of the architecture 300 in predicting weed growth. Here, the curves 602-606 plot chemical (herbicide) savings against false negative rates. The chemical savings are plotted along the horizontal axis and represent a measure of reduced herbicide usage compared to performing a broadcast or blanket herbicide application. The false negative rates are plotted along the vertical axis and represent estimates of the number of areas where herbicide is not applied but should have been. A false negative therefore refers to a failure to correctly apply herbicide in order to prevent weed growth.

In this example, a curve 602 is associated with random spraying, meaning herbicide is randomly applied to a field or other growing area without knowledge of weed locations. As expected, such a random approach might be generally linear, which indicates that the false negative rate increases as fewer areas are randomly sprayed. A curve 604 is associated with perfect prediction where it is assumed that the location of every weed is known. A curve 606 is an example curve associated with operation of the architecture 300, where the architecture 300 is generally effective at predicting weed locations but may miss some predictions due to various factors (such as lack of appropriate data or weed germination in new areas).

As shown in FIG. 6B, a graph 610 associates chemical savings against false negative rates for different tunings of the architecture 300. In this example, a curve 612 indicates that the false negative rate can remain relatively low when more conservative tunings are used (one of which is represented using a point 614). These more conservative tunings generally represent configurations of the architecture 300 in which larger areas are likely to be sprayed or otherwise treated in order to prevent weeds from germinating or growing. In some cases, this may be achieved by using a larger buffer zone around each boundary of a weed cluster to account for at least one unobserved portion of a weed population and/or using a larger additional area around each boundary of a weed cluster to account for a distance at which a weed population is predicted to spread within a specified time window. As a result, the more conservative tunings can typically result in over-treatment, which can increase herbicide or other material usage and cost. However, this is accompanied by a lower likelihood of missing weeds, resulting in higher weed suppression.

In contrast, the curve 612 here indicates that the false negative rate can increase significantly when more aggressive tunings are used (one of which is represented using a point 616). These more aggressive tunings generally represent configurations of the architecture 300 in which smaller areas are likely to be sprayed or otherwise treated in order to prevent weeds from germinating or growing. In some cases, this may be achieved by using a smaller buffer zone around each boundary of a weed cluster to account for at least one unobserved portion of a weed population and/or using a smaller additional area around each boundary of a weed cluster to account for a distance at which a weed population is predicted to spread within a specified time window. As a result, the more aggressive tunings can typically result in under-treatment, which can decrease herbicide or other material usage and cost. However, this is accompanied by a higher likelihood of missing weeds, resulting in lower weed suppression.

Based on this, it is possible to provide desired trade-offs to users by allowing suitable tunings to be used for those users. Thus, growers who are more interested in weed suppression and less interested in herbicide/material usage and cost reductions may use more conservative tunings. Growers who are more interested in herbicide/material usage and cost reductions and less interested in weed suppression may use more aggressive tunings. If desired, the same grower may also adjust the tunings over time, such as when more conservative tunings are used earlier in a growing season and more aggressive tunings are used later in a growing season (or vice versa).

One example of this trade-off is illustrated in FIG. 6C, where a prediction 620 represents operation of the architecture 300 using a standard or default tuning. A prediction 622 represents operation of the architecture 300 using a more conservative tuning, which results in a larger area being identified as likely having weeds and needing treatment. A prediction 624 represents operation of the architecture 300 using a more aggressive tuning, which results in a smaller area being identified as likely having weeds and needing treatment. As noted above, a grower associated with a particular field or other growing area can select the desired tuning based on the goal(s) of the grower at that time. If necessary or desirable, the grower may change this tuning over time. A wide range of performances may be available based on the selected tunings. In many cases, the typical preference for a growing area may be to apply treatment to about 90-95% of the weeds in the growing area and then save as much herbicide or other material(s) as possible.

Although FIGS. 6A through 6C illustrate examples of possible tunings for predictions of weed locations in a field or other growing area and associated results, various changes may be made to FIGS. 6A through 6C. For example, the specific predictions and the specific curves shown here are examples only and are merely meant to illustrate how some embodiments of the architecture 300 may be tuned and operated. The actual tunings, predictions, and results obtained can easily vary depending on the circumstances, such as based on the actual data available for processing and how the architecture 300 is actually implemented.

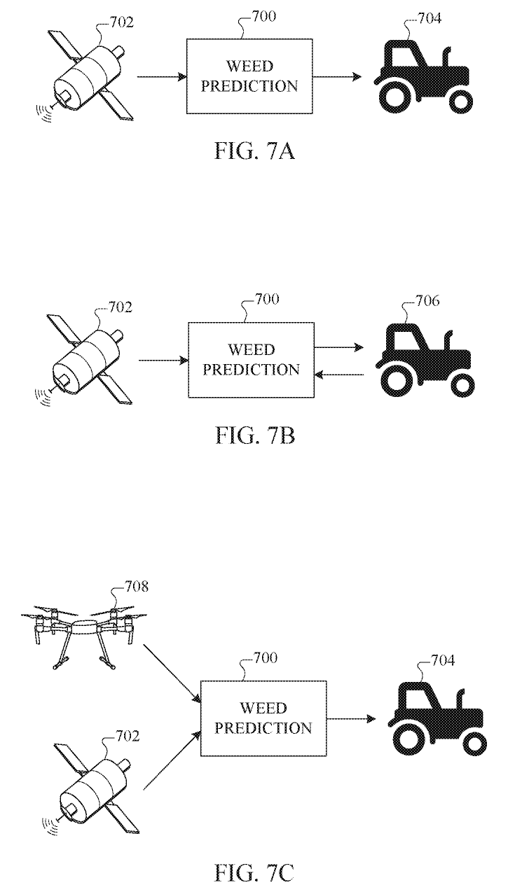

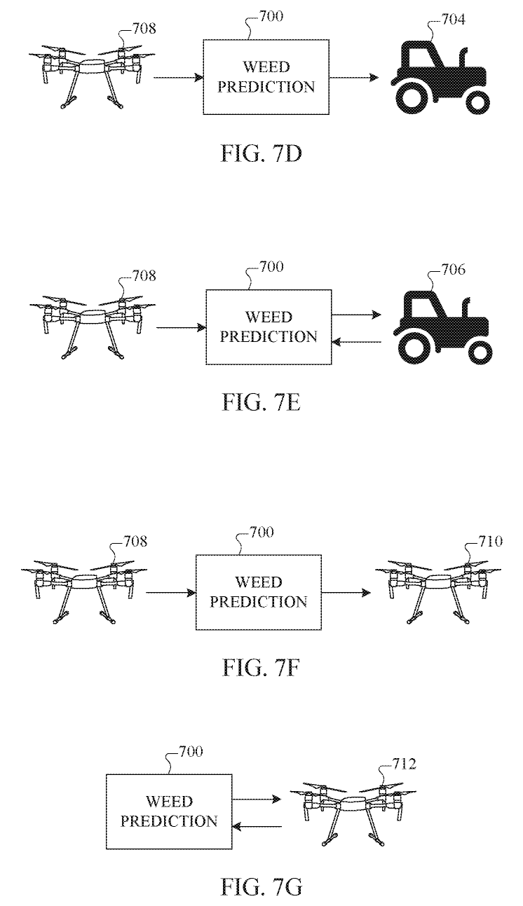

FIGS. 7A through 7G illustrate specific examples of systems in which predictions of weed locations in a field or other growing area may be used according to this disclosure. More specifically, FIGS. 7A through 7G illustrate example ways in which the architecture 300 may be implemented and used with other devices to support weed control in one or more growing areas. In FIGS. 7A through 7G, a weed prediction platform 700 generally represents an implementation of the architecture 300.

As shown in FIG. 7A, the weed prediction platform 700 may receive data from one or more satellites 702, and the weed prediction platform 700 may provide predictions for use by at least one tractor 704. The one or more satellites 702 may provide any suitable data, such as multi-spectral data (like NDVI data). The at least one tractor 704 may include one or more tractors equipped with one or more traditional non-sensing sprayers (meaning sprayers not equipped with cameras to sense weeds) or other non-sensing treatment systems. Here, the weed prediction platform 700 may be used to generate one or more recommended treatment maps, and the at least one tractor 704 can be used to spray herbicide or otherwise deliver treatment(s) based on the one or more recommended treatment maps.

As shown in FIG. 7B, the weed prediction platform 700 may receive data from one or more satellites 702 and from at least one tractor 706. The at least one tractor 706 may include one or more tractors equipped with one or more sensing sprayers (meaning the sprayers are equipped with cameras or other equipment to sense weeds) or other sensing treatment systems. Thus, the weed prediction platform 700 could receive data identifying weeds from both the one or more satellites 702 and the at least one tractor 706. The one or more satellites 702 may provide any suitable data, such as multi-spectral data or multi-spectral metrics (like NDVI data). The at least one tractor 706 may also provide any suitable data, such as locations of detected weeds. Here, the weed prediction platform 700 may be used to generate one or more recommended treatment maps, and the at least one tractor 706 can be used to spray herbicide or otherwise deliver treatment(s) based on the one or more recommended treatment maps.

As shown in FIG. 7C, the weed prediction platform 700 may receive data from one or more satellites 702 and from one or more survey drones 708. The one or more survey drones 708 can represent one or more drones that can survey crops and identify (but not treat) weeds. The one or more satellites 702 may provide any suitable data, such as multi-spectral data (like NDVI data). The one or more survey drones 708 may also provide any suitable data, such as lower-resolution NDVI data or higher-resolution computer vision object detection data. Here, the weed prediction platform 700 may be used to generate one or more recommended treatment maps, and the at least one tractor 704 can be used to spray herbicide or otherwise deliver treatment(s) based on the one or more recommended treatment maps. While not shown here, the at least one tractor 704 may include or be replaced by at least one tractor 706, which could provide additional weed-related data to the weed prediction platform 700.

If satellite data is not available, other system configurations may be used. For example, as shown in FIG. 7D, the weed prediction platform 700 may receive data from one or more survey drones 708. The one or more survey drones 708 may provide any suitable data, such as lower-resolution NDVI data or higher-resolution computer vision object detection data. Here, the weed prediction platform 700 may be used to generate one or more recommended treatment maps, and the at least one tractor 704 can be used to spray herbicide or otherwise deliver treatment(s) based on the one or more recommended treatment maps. As shown in FIG. 7E, the weed prediction platform 700 may receive data from one or more survey drones 708 and from at least one tractor 706. The one or more survey drones 708 may provide any suitable data, such as lower-resolution NDVI data or higher-resolution computer vision object detection data. The at least one tractor 706 may also provide any suitable data, such as locations of detected weeds. Here, the weed prediction platform 700 may be used to generate one or more recommended treatment maps, and the at least one tractor 706 can be used to spray herbicide or otherwise deliver treatment(s) based on the one or more recommended treatment maps.

As shown in FIG. 7F, the weed prediction platform 700 may receive data from one or more survey drones 708. The one or more survey drones 708 may provide any suitable data, such as lower-resolution NDVI data or higher-resolution computer vision object detection data. Here, the weed prediction platform 700 may be used to generate one or more recommended treatment maps, and one or more treatment drones 710 can be used to spray herbicide or otherwise deliver treatment(s) based on the one or more recommended treatment maps. Each treatment drone 710 can represent a drone configured to deliver one or more herbicides or other treatments to weeds within a field or other growing area.

As shown in FIG. 7G, the weed prediction platform 700 may be used in conjunction with one or more surveying and treatment drones 712, which can be used to both survey crops to identify weeds and to apply treatment(s) to the weeds. Here, the weed prediction platform 700 may be used to generate one or more recommended treatment maps based on information from the one or more surveying and treatment drones 712, and the one or more surveying and treatment drones 712 can be used to spray herbicide or otherwise deliver treatment(s) based on the one or more recommended treatment maps.

Note that the weed prediction platform 700 may be implemented in any suitable manner. In some cases, for instance, the weed prediction platform 700 may be implemented on a local computing device, such as a local application server 106 or user device 102a-102d. In these cases, the weed prediction platform 700 may interact with the tractor(s) 704, 706 and/or drone(s) 708, 710, 712 over a local area network. In other cases, the weed prediction platform 700 may be implemented on a remote computing device, such as on a remote server, or in a cloud computing environment. In those cases, the weed prediction platform 700 may interact with the tractor(s) 704, 706 and/or drone(s) 708, 710, 712 over the local area network and a broader network (such as a MAN, WAN, or global network). In still other cases, the weed prediction platform 700 may be implemented on a tractor 704 or 706, drone 708, 710, 712, or other vehicle used to survey or treat crops. In general, this disclosure is not limited to any specific physical implementation of the architecture 300 or the weed prediction platform 700.

Although FIGS. 7A through 7G illustrate specific examples of systems in which predictions of weed locations in a field or other growing area may be used, various changes may be made to FIGS. 7A through 7G. For example, the weed prediction platform 700 may be used in any other suitable manner and in any other suitable system, and the architecture 300 and the weed prediction platform 700 are not limited to use in the specific systems shown here.

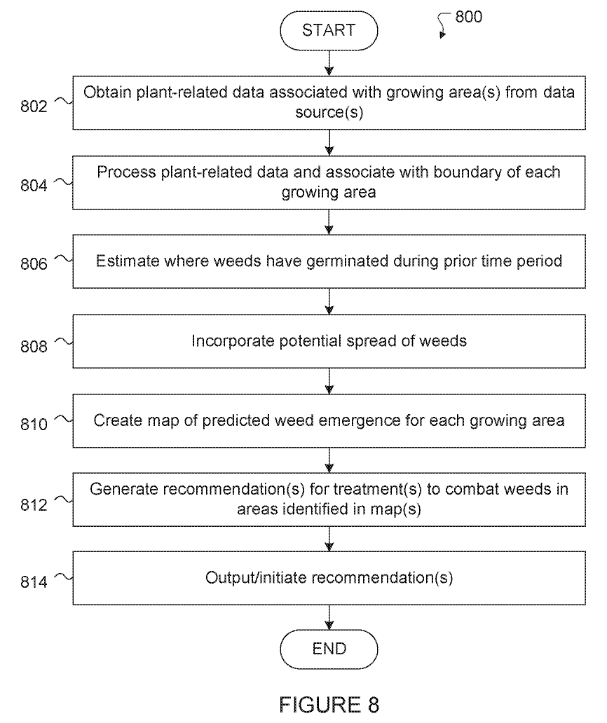

FIG. 8 illustrates an example method 800 for predicting weed locations in a field or other growing area according to this disclosure. For ease of explanation, the method 800 of FIG. 8 is described as being implemented using the application server 106 in the system 100 of FIG. 1, where the application server 106 may be implemented using one or more instances of the device 200 of FIG. 2 and may implement at least part of the architecture 300 of FIG. 3. However, the method 800 may be implemented using any other suitable device(s) and in any other suitable system(s), and the method 800 may be used with any other suitable architecture(s).

As shown in FIG. 8, plant-related data associated with one or more growing areas is obtained from one or more data sources at step 802. This may include, for example, the at least one processing device 202 of the application server 106 obtaining plant-related data from one or more data sources 302. Any suitable plant-related data may be obtained here, such as satellite images, drone images, smart tractor/drone/other sprayer data, human-collected scouting data, meteorological data, soil type data, weed species data, management practices data, or any suitable combination thereof.

The plant-related data is processed and associated with a boundary of each growing area at step 804. This may include, for example, the at least one processing device 202 of the application server 106 performing the one or more data processing functions 304 to process the plant-related data and place the data in a common or standardized format. This may also include the at least one processing device 202 of the application server 106 performing the one or more data processing functions 304 to process the plant-related data and identify which data corresponds to which growing area and to identify the boundary of each growing area. In some cases, for instance, the boundary of each growing area may be identified using one or more images of the growing area.

Estimates of where weeds have germinated during a prior time period are generated at step 806. This may include, for example, the at least one processing device 202 of the application server 106 performing the at least one machine learning-based or other spatial analysis function 306 to retrieve or generate weed maps identifying where weeds have been located in the prior time period (such as from one to ten years ago) in each growing area. This may also include the at least one processing device 202 of the application server 106 performing the at least one spatial analysis function 306 to analyze weather data, crops currently planted or to be planted in each growing area, and/or other information to estimate where weeds are likely to germinate and grow within a relevant time window (such as during the current growing season). As part of this, the at least one spatial analysis function 306 can cluster weeds into groups, identify a boundary of each cluster, and add a buffer zone around each boundary to account for at least one unobserved portion of a weed population.

The potential spread of the weeds is incorporated at step 808. This may include, for example, the at least one processing device 202 of the application server 106 performing the weed spread prediction function 308 to estimate how the predicted weed populations might spread in the relevant time window (such as during the current growing season). As a particular example, the weed spread prediction function 308 may add an additional area around each boundary to account for a distance at which the associated weed population is estimated to spread within the relevant time window. In some cases, this could be based on how weeds in similar locations or growing areas previously spread.

A map of predicted weed emergence is generated for each growing area at step 810. This may include, for example, the at least one processing device 202 of the application server 106 using the results of the spatial analysis as generated by the at least one spatial analysis function 306 and as expanded by the weed spread prediction function 308 to identify (graphically or otherwise) locations in each growing area where weeds are predicted to germinate and grow within the relevant time window.

The resulting predictions may optionally be used to generate one or more recommendations of one or more treatments to combat the weeds in identified areas of the map(s) at step 812, and the one or more recommendations may optionally be output or initiated at step 814. This may include, for example, the at least one processing device 202 of the application server 106 performing the recommendation generation/implementation function 312 to generate recommendations of one or more treatments for each growing area. Example treatments may include an herbicide application, a multi-rate herbicide application, a multi-herbicide application, an increase in seeding density, a change in crop, a blanket herbicide application, and/or a targeted nutrient/fertilizer application. The one or more recommendations may be presented to a user for approval or implementation, or the one or more recommendations may be used to automatically initiate one or more treatments (with or without user approval).

Although FIG. 8 illustrates one example of a method 800 for predicting weed locations in a field or other growing area, various changes may be made to FIG. 8. For example, while shown as a series of step, various steps in FIG. 8 may overlap, occur in parallel, occur in a different order, or occur any number of times (including zero times).

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining plant-related information associated with a growing area, the plant-related information including information identifying multiple weeds detected within the growing area; and processing at least some of the plant-related information to estimate at least one location at risk of weed germination in the growing area, wherein processing at least some of the plant-related information comprises estimating the at least one location at risk of weed germination based at least partially on locations where the identified weeds were detected within the growing area.

2. The method of claim 1, further comprising:
generating a recommendation of one or more treatments to the at least one location at risk of weed germination in the growing area.

3. The method of claim 1, further comprising:
automatically initiating application of one or more treatments to the at least one location at risk of weed germination in the growing area.

4. The method of claim 3, wherein the one or more treatments comprise at least one of:
application of one or more herbicides to the at least one location at risk of weed germination in the growing area; a multi-rate application of one or more herbicides to the at least one location at risk of weed germination in the growing area; a multi-herbicide application of multiple herbicides to the at least one location at risk of weed germination in the growing area; an increase in seeding density in the at least one location at risk of weed germination in the growing area;
a change in crop in the at least one location at risk of weed germination in the growing area; a blanket application of one or more herbicides to the at least one location at risk of weed germination in the growing area; and a targeted application of one or more nutrients and/or fertilizer to the at least one location at risk of weed germination in the growing area.

5. The method of claim 1, wherein estimating the at least one location at risk of weed germination comprises performing clustering based on the locations where the identified weeds were detected within the growing area.

6. The method of claim 5, wherein performing the clustering comprises using a machine learning clustering algorithm.

7. The method of claim 1, wherein processing at least some of the plant-related information further comprises:
identifying the locations where the weeds were detected; determining distances between the locations where the weeds were detected, the at least one location at risk of weed germination identified based on the distances; and removing any of the locations that have not been assigned to a cluster of weeds.

8. The method of claim 1, wherein processing at least some of the plant-related information further comprises:
identifying a boundary around each of one or more clusters of weeds; and
adding a buffer zone around each boundary to account for at least one unobserved portion of a weed population.

9. The method of claim 8, wherein processing at least some of the plant-related information further comprises:
adding an additional area around each boundary to account for a distance at which a weed population is predicted to spread within a specified time window.

10. An apparatus comprising:
at least one processing device configured to:
obtain plant-related information associated with a growing area, the plant-related information including information identifying multiple weeds detected within the growing area; and process at least some of the plant-related information to estimate at least one location at risk of weed germination in the growing area, wherein, to process at least some of the plant-related information, the at least one processing device is configured to estimate the at least one location at risk of weed germination based at least partially on locations where the identified weeds were detected within the growing area.

11. The apparatus of claim 10, wherein the plant-related information comprises at least one of:
plant-related information provided by one or more satellites; plant-related information provided by at least one ground-based or airborne vehicle having a delivery system configured to identify weeds and apply one or more treatments to those weeds; and plant-related information provided by at least one ground-based or airborne vehicle configured to survey the growing area.

12. The apparatus of claim 10, wherein, to process at least some of the plant-related information, the at least one processing device is further configured to:
identify at least one boundary of the growing area; combine plant-related information obtained over time; and generate one or more weed maps using the plant-related information.

13. The apparatus of claim 10, wherein, to process at least some of the plant-related information, the at least one processing device is further configured to:
identify at least one boundary of the growing area; combine plant-related information obtained from different data sources; and generate one or more weed maps using the plant-related information.

14. The apparatus of claim 13, wherein the plant-related information obtained from different data sources comprises:
lower-fidelity data obtained more frequently; and higher-fidelity data obtained less frequently.

15. The apparatus of claim 10, wherein the plant-related information further comprises at least one of: human-collected scouting data, meteorological data, soil type data, weed species data, and data defining one or more management practices.

16. The apparatus of claim 10, wherein the at least one processing device is further configured to analyze multi-spectral data contained in one or more images of the growing area to differentiate the weeds from crops or identify weed species and identify the locations where the identified weeds are detected.

17. The apparatus of claim 10, wherein the at least one processing device is further configured to estimate a quantity of herbicide needed to spot-treat the growing area for use in preparing the estimated quantity of herbicide to spot-treat the growing area.

18. A non-transitory computer readable medium storing computer readable program code that when executed causes at least one processor to:
obtain plant-related information associated with a growing area, the plant-related information including information identifying multiple weeds detected within the growing area; and process at least some of the plant-related information to estimate at least one location at risk of weed germination in the growing area;
wherein the computer readable program code that when executed causes the at least one processor to process at least some of the plant-related information comprises:
computer readable program code that when executed causes the at least one processor to estimate the at least one location at risk of weed germination based at least partially on locations where the identified weeds were detected within the growing area.

19. The non-transitory computer readable medium of claim 18, further containing computer readable program code that when executed causes the at least one processor to automatically initiate application of one or more treatments to the at least one location at risk of weed germination in the growing area.

20. The non-transitory computer readable medium of claim 19, wherein the one or more treatments comprise at least one of:
application of one or more herbicides to the at least one location at risk of weed germination in the growing area; a multi-rate application of one or more herbicides to the at least one location at risk of weed germination in the growing area; a multi-herbicide application of multiple herbicides to the at least one location at risk of weed germination in the growing area; an increase in seeding density in the at least one location at risk of weed germination in the growing area;
a change in crop in the at least one location at risk of weed germination in the growing area; a blanket application of one or more herbicides to the at least one location at risk of weed germination in the growing area; and a targeted application of one or more nutrients and/or fertilizer to the at least one location at risk of weed germination in the growing area.
